(19) United States
(12) Patent Application Publication
(10) Pub. No.: US 2015/0093158 A1
(43) Pub. Date: Apr. 2, 2015

(54) IMAGE FORMING APPARATUS

(71) Applicant: Oki Data Corporation, Tokyo (JP)

(72) Inventors: Takaaki EBE, Tokyo (JP); Akihito ONISHI, Tokyo (JP)

(21) Appl. No.: 14/483,327

(22) Filed: Sep. 11, 2014

(30) Foreign Application Priority Data
Sep. 27, 2013 (JP) 2013-201160
Sep. 27, 2013 (JP) 2013-201201

(51) Int. Cl. G03G 15/08

(52) U.S. Cl. CPC G03G 15/0808
USPC 399/286

(57) ABSTRACT

An image forming apparatus suppressing jitter from occurring includes an image carrier, and a developer carrier supplying a developer to the image carrier, wherein the developer carrier includes an elastic layer having a thickness of 2.5 mm or less and having an MD-1 hardness of 40 degrees or more.

### CROSS REFERENCE TO RELATED APPLICATIONS

This application claims priority benefits under 35 USC, section 119 on the basis of Japanese Patent Application No. 2013-201160 and Japanese Patent Application No. 2013-201201, the disclosure of which is incorporated herein by reference.

### BACKGROUND OF THE INVENTION

1. Field of the Invention

This invention relates to an image forming apparatus.

2. Description of Related Art

An image forming apparatus using a conventional electrophotographic method incorporates a developing device, which includes such as, e.g., an electrostatic latent image carrier, a charge member operable to the latent image carrier, a developer carrier, and a cleaning mechanism in a united body, to form developer images on a recording medium using the electrophotographic method.

Such an image forming apparatus, however, tends to suffer from inferior printing images caused from a developing roller as the developer carrier.

### SUMMARY OF THE INVENTION

It is therefore an object of the invention to provide an image forming apparatus preventing images from being printed with a lower quality caused from a developing roller.

According to one aspect of the invention, an image forming apparatus comprises an image carrier and a developer carrier supplying a developer to the image carrier, wherein the developer carrier includes an elastic layer having a thickness of 2.5 mm or less and having an MD-1 hardness of 40 degrees or more.

### BRIEF DESCRIPTION OF THE DRAWINGS

The above and other objects and features of the present invention will become apparent from the following detailed description and the appended claims with reference to the accompanying drawings.

FIG. 1 is a schematic cross section showing a structure of an image forming apparatus according to an embodiment of the invention;

FIG. 2 is a schematic cross section showing a structure of a developing device according to the embodiment;

FIG. 3 is a block diagram showing a control system of the image forming apparatus according to the embodiment;

FIG. 4 is a schematic cross section showing an attachment structure of a drum unit and a developing unit according to the embodiment;

FIG. 5 is a schematic view showing a drive mechanism of the image forming apparatus according to the embodiment, when viewed from a direction perpendicular to an axial direction of the photosensitive drum and the developing roller;

FIG. 6 is a schematic view showing the drive mechanism of the image forming apparatus according to the embodiment, when viewed from the axial direction of the photosensitive drum and the developing roller;

FIG. 7 is a schematic cross section showing a structure of a developing roller according to the embodiment,

FIGS. 8A, 8B are schematic views showing a measuring method of a resistance value of the developing roller according to the embodiment.

FIG. 9 is an illustration for describing a full solid image used in the embodiment;

FIG. 10 is an illustration for describing a two by two image used in the embodiment, and

FIG. 11 is a cross section showing a developing roller having a hollow core metal.

### DETAILED DESCRIPTION OF EMBODIMENTS

Referring to the drawings, embodiments of a medium delivery apparatus and an image forming apparatus according to this invention are described.

### First Embodiment

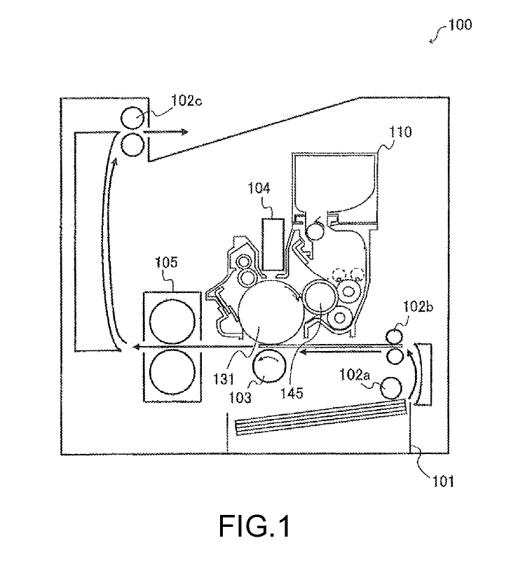

FIG. 1 is a schematic cross section showing a structure of an image forming apparatus 100 according to the first embodiment. The image forming apparatus 100 includes a medium container 101, conveyance rollers 102a, 102b, 102c, a transfer roller 103, an LED head 104, a fixing device 105, and a developing device 110.

The medium container 101 contains the paper as a recording medium. The conveyance rollers 102a, 102b, 102c convey the paper. The transfer roller 103 transfers toner images serving as developer images formed at the developing device 110 to the paper. The LED head 104 forms electrostatic latent images on a photosensitive drum 131 by exposing the photosensitive drum 131 described below. The fixing device 105 fixes the toner images transferred onto the paper. The developing device 110 forms the toner images.

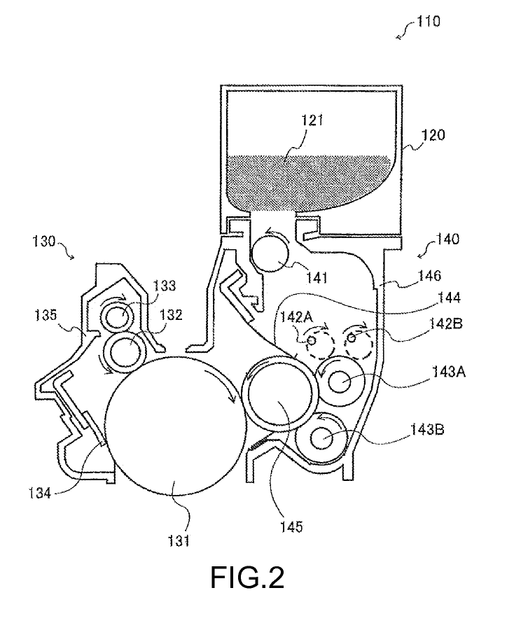

FIG. 2 is a schematic cross section showing a structure of the developing device 110. The developing device 110 includes a toner container 120 as a developer container, a drum unit 130 as a first unit, and a developing unit 140 as a second unit.

The toner container 120 contains a toner 121. The drum unit 130 receives the toner from the developing unit 140 and forms the toner images. The developing unit 140 receives toner supply from the toner container 120 and provides the toner to the drum unit 130. The toner container 120 is detachably attached to the developing unit 140. The drum unit 130 and the developing unit 140 are detachably attached to the image forming apparatus 100, respectively.

The drum unit 130 includes the photosensitive drum 131, a charge roller 132, a cleaning roller 133, a cleaning blade 134, and a drum unit casing 135. The photosensitive drum 131 is the image carrier forming electrostatic latent images and toner images thereon. The charge roller 132 is a charging member charging the surface of the photosensitive drum 131. The cleaning roller 133 removes the toner 121 and other additives attached to the charge roller 132. The cleaning blade 134 scrapes off the transfer-remaining toner on the photosensitive drum 131. The cleaning roller 133 and the cleaning blade 134 form the cleaning mechanism for removing unnecessary toners. The drum unit casing 135 is a casing containing the photosensitive drum 131, the charge roller 132, the cleaning roller 133, and the cleaning blade 134, and renders the drum unit 130 detachably attached to the image forming apparatus 100.

The developing unit 140 includes a replenishment roller 141, a first stirring member 142A, a second stirring member 142B, a first supply roller 143A, a second supply roller 143B, a developing blade 144, a developing roller 145, and a developing unit casing 146.

The replenishment roller 141 is a replenishment member for replenishing the toner 121 supplied from the toner container 120 to an interior of the developing unit 140. The first stirring member 142A and the second stirring member 142B are stirring members for stirring the toner 121 inside the developing unit 140. For example, the first stirring member 142A and the second stirring member 142B are made of bars in a crank shape and rotate in an arrow direction along the broken lines, respectively in FIG. 2. The first supply roller 143A and the second supply roller 143B are supply members for supplying the toner to the developing roller 145. The developing blade 144 is a restriction member for restricting the thickness of the toner 121 supplied to the developing roller 145 to form a thin layer of the toner 121 on the developing roller 145. The developing roller 145 is a developer carrier for supplying the toner to the photosensitive drum 131. For example, the developing roller 145 is disposed in facing the photosensitive drum 131 to attach the toner to electrostatic latent images formed on the surface of the photosensitive drum 131. The developing unit casing 146 is a casing containing the replenishment roller 141, the first stirring member 142A, the second stirring member 142B, the first supply roller 143A, the second supply roller 143B, the developing blade 144, and the developing roller 145, and renders the developing unit 140 detachably attached to the image forming apparatus 100.

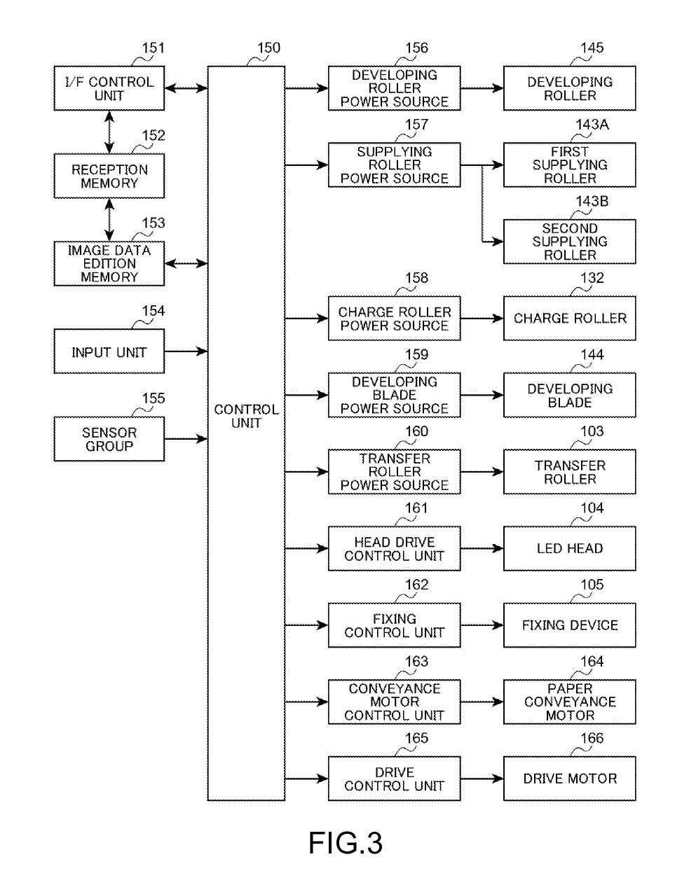

FIG. 3 is a block diagram showing a control system of the image forming apparatus 100. A control unit 150 controls entire processing in the image forming apparatus 100. For example, the control unit 150 receives printing data as image forming data and control commands via an interface control unit (hereinafter referred to as “I/F control unit”) 151, and controls sequences of the whole image forming apparatus 100 to perform printing operation (or namely image forming operation). The control unit 150 is structures of such as, e.g., a microprocessor, ROMs, RAMs, and input/output ports, and performs processings by executing predetermined programs.

A reception memory 152 memorizes temporarily the printing data entered via the I/F control unit 151 from the host apparatus. An image data edition memory 153 receives the printing data stored in the reception memory 152 and memorizes image data formed by edition processing of the printing data. An input unit 154 is formed with an entry unit for receiving entries of manipulations from an operator and with a display unit for displaying information for the operator. For example, the input unit 154 includes LEDs for indicating the status of the image forming apparatus 100, switches for receiving instructions from the operator at the image forming apparatus 100 as well as a display screen or screens. A sensor group 155 is made of various sensors for monitoring the operation condition of the image forming apparatus 100. For example, the sensor group 155 includes such as, e.g., a paper position detection sensor, a temperature and humidity sensor, a printing density sensor, and a toner remaining amount detection sensor.

A developing roller power source 156 applies a voltage to the developing roller 145. By applying the voltage to the developing roller 156, the toner 121 carried on the developing roller 145 is attached to the electrostatic latent images formed on the surface of the photosensitive drum 131. A supply roller power source 157 applies voltages to the first supply roller 143A and the second supply roller 143B. This allows the toner 121 to be supplied from the first supply roller 143A and the second supply roller 143B to the developing roller 145. A charge roller power source 158 applies a voltage to the charge roller 132 according to an instruction from the control unit 150. This allows the surface of the photosensitive drum 131 to be charged. A developing blade power source 159 applies a voltage to the developing blade 144. This allows the toner to be formed as the thin layer on the surface of the developing roller 145. A transfer roller power source 160 applies a voltage to the transfer roller 103. This allows the toner images formed on the surface of the photosensitive drum 131 to be transferred onto the recording medium. It is to be noted that the developing roller power source 156, the supply roller power source 157, the charge roller power source 158, the developing blade power source 159, and the transfer roller power source 160 can change the applying voltage according to the instruction of the control unit 150.

A head drive control unit 161 sends the image data memorized in the image data edition memory 153 to the LED head 104 and drives the LED head 104. The fixing control unit 162 applies a voltage to the fixing device 105 as a fixing means to fix the transferred toner images onto the recording medium. For example, the fixing device 105 includes such as, e.g., a heater melting the toner 121 on the recording medium and a temperature sensor detecting the temperature. The fixing control unit 162 reads the sensor output of the temperature sensor and controls to energize the heater according to the sensor output so as to make the fixing device 105 keep a constant temperature. A conveyance motor control unit 163 controls a paper conveyance motor 164 for conveying the recording medium. For example, the conveyance motor control unit 163 conveys and stops the recording medium at predetermined timings according to the instruction from the control unit 150. A drive control unit 165 controls drive of a drive motor 166 for rotating such as the developing roller 145 and the photosensitive drum 131.

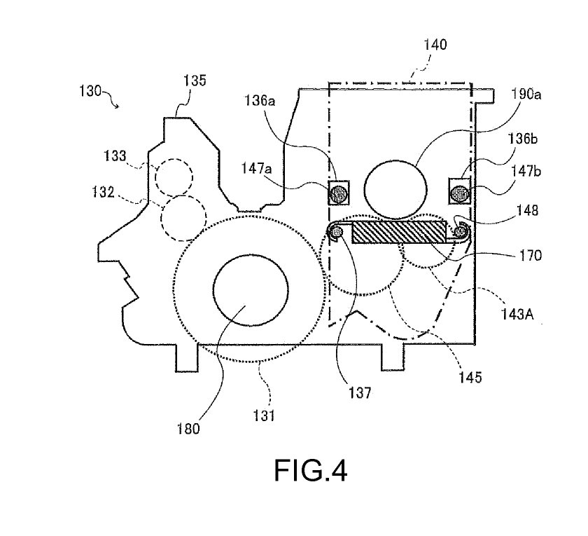

Next, a drive method of the developing device 110 is described. FIG. 4 is a schematic cross section showing an attachment structure of the drum unit 130 and the developing unit 140. In FIG. 4, the developing unit 140 shown with a dotted chain line is formed with a first post 147a and a second post 147b. The drum unit 130 is formed with a first post receiver 136a and a second post receiver 136b. The first post 147a and the second post 147b are inserted into the first post receiver 136a and the second post receiver 136b, respectively, so that the drum unit 130 can maintain the developing unit 140 in a horizontal manner.

A spring 170 is engaged between a first holder 137 formed at the drum unit 130 and a second holder 148 formed at the developing unit 140. The spring 170 has an elasticity and is an urging member urging at least either one of the first holder 137 and the second holder 148 to contact the photosensitive drum 131 with the developing roller 145. In the first embodiment, the spring 170 urges the developing roller 145 toward the photosensitive drum 131, so that the developing roller 145 is pressed with prescribed pressure to the photosensitive drum 131. The spring 170 is engaged to the first holder 137 at one end and engaged to the second holder 148 at the other end to produce elastic force in a direction contracting the spring 170.

The photosensitive drum 131 is rotated as transmitting drive force to a drum coupling receiver 180 formed at one end of the photosensitive drum 131. The charge roller 132 rotates as rotation of the photosensitive drum 131. One ends of the charge roller 132 and the cleaning roller 133 are formed with gears not shown, and the gears make the cleaning roller 133 rotate with a circumferential speed difference with respect to the charge roller 132.

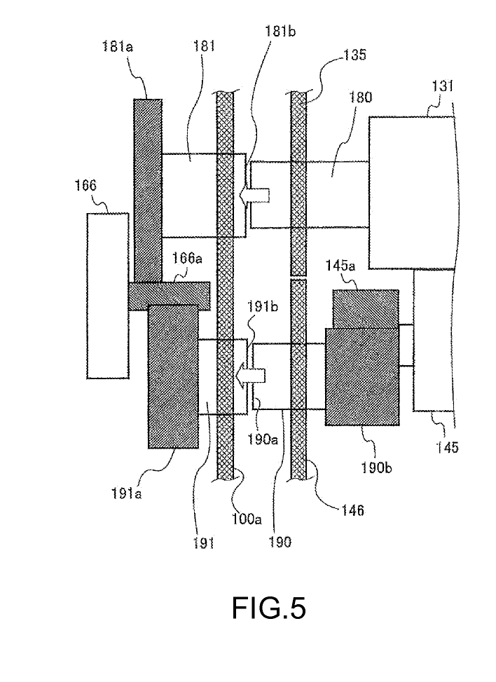

The developing roller 145 and the first supply roller 143A are rotated as transmitting drive force to a developing unit coupling receiver 190a. A developing unit idle gear 190b is provided on one end, which is opposite to an end that the developing unit coupling receiver 190a is formed (see, FIG. 5). The developing unit idle gear 190b meshes a developing roller gear 145a and a first supply roller gear 143Aa. It is to be noted that the drum coupling receiver 180 is supported by the drum unit casing 135, and the developing unit coupling receiver 190a is supported by the developing unit casing 146 (see, FIG. 2).

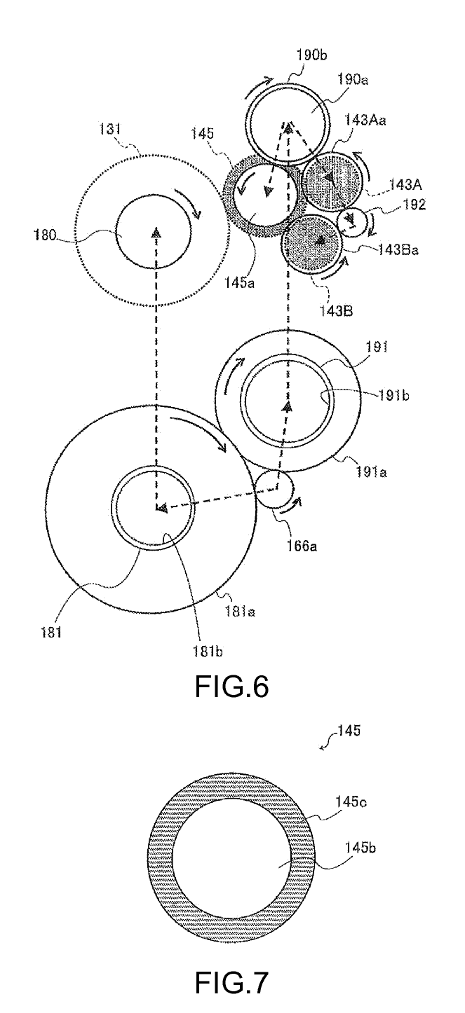

Referring to FIGS. 5, 6, a transmission route of drive force is described. FIG. 5 is a schematic view showing a drive mechanism of the image forming apparatus 100 when viewed from a direction perpendicular to an axial direction of the photosensitive drum 131 and the developing roller 145. FIG. 6 is a schematic view showing the drive mechanism of the image forming apparatus 100 when viewed from the axial direction of the photosensitive drum 131 and the developing roller 145. In FIG. 6, a solid line arrow indicates a rotation direction, and a broken line arrow indicates a transmission route of drive.

As shown in FIG. 5, the rotation drive force of the drive motor 166 as a drive source is transmitted to the photosensitive drum 131 via a drive motor gear 166a as a first gear and via a drum coupling 181 as a first coupling member. The rotation drive force of the drive motor 166 as a drive source is transmitted to the developing roller 145 via the drive motor gear 166a, a developing unit coupling 191 as a second coupling member, a connection member 190, and a developing roller gear 145a as a fifth gear. As shown in FIG. 5, the drive motor gear 166a is coupled with the rotation shaft of the drive motor 166. A drum gear 181a serving as a second gear is provided at one end of the drum coupling 181, and a drum fitting hole 181b serving as a first fitting hole is provided at the other end of the drum coupling 181 (see, FIG. 6). A developing unit gear 191a as a third gear is provided at one end of the developing unit coupling 191, and a connection fitting hole 191b as a second fitting hole is provided at the other end of the developing unit coupling 191 (see, FIG. 6). A developing unit coupling receiver 190a as a second coupling receiver is provided at one end of the connection member 190, and a developing unit idle gear 190b as a fourth gear is provided at the other end of the connection member 190. The drum gear 181a and the developing unit gear 191a mesh the drive motor gear 166a, and rotate in the arrow direction shown in FIG. 6 according to the rotation of the drive motor gear 166a. The drum coupling 181 and the developing unit coupling 191 are provided at the image forming apparatus 100 and are supported at a side plate 100a of the image forming apparatus 100.

Where the developing device 110 is mounted in the image forming apparatus 100, the drum fitting hole 181b of the drum coupling 181 fits the drum coupling receiver 180 as the first coupling receiver. With this mechanism, the photosensitive drum 131 coupling the drum coupling receiver 180 as well as the drum coupling 181 rotate in the arrow direction shown in FIG. 6. The connection fitting hole 191b of the developing unit coupling 191 fits the developing unit coupling receiver 190a of the connection member 190. The developing unit idle gear 190b formed at the other end of the connection member 190 meshes developing roller gear 145a formed one end of the developing roller 145. With this mechanism, the developing roller 145, the connection member 190, and the developing unit coupling 191 rotate in the arrow direction shown in FIG. 6.

As shown in FIG. 6, the developing roller gear 145a is provided at one end of the developing roller 145. A first supply roller gear 143Aa is provided at one end of the first supply roller 143A. The developing unit idle gear 190b meshes the developing roller gear 145a and the first supply roller gear 143Aa, and the developing roller 145 and the first supply roller 143A rotates in the arrow direction shown in FIG. 6 according to the rotation of the developing unit coupling receiver 190a. As shown in FIG. 6, an idle gear 192 is arranged between the first supply roller gear 143Aa and a second supply roller gear 143Ba provided at one end of the second supply roller 143B, thereby rotating the first supply roller 143A and the second supply roller 143B in the same direction.

As shown in FIG. 5 and FIG. 6, the drum gear 181a for image carrier rotating the photosensitive drum 131 does not directly mesh any of the gears 145a, 190b, 191a for developer carrier rotating the developing roller 145, but meshes the drive motor gear 166a formed at the drive motor 166 as the drive source. Accordingly, the drive force for rotating the photosensitive drum 131 and the drive force for rotating the developing roller 145 are inputted separately. It is considered that one of causes of jitter is from rotational unevenness due to shaking behavior of gear meshing, and occurrences of such jitter from the cause of rotational unevenness due to shaking behavior of gear meshing can be suppressed by structuring the image carrier gear for rotating the photosensitive drum 131 and the developer carrier gear for rotating the developing roller 145 as not meshing directly each other. It is to be noted that the image forming apparatus may include plural drive motors as drive sources to separately mesh the image carrier gear for rotating the photosensitive drum 131 and the developer carrier gear for rotating the developing roller 145 with drive motor gears formed at drive motors, respectively, thereby further suppressing rotational unevenness.

Essential structural components of the developing device 110 are described more specifically. The toner 121 used in this embodiment is a negatively charged toner of non-magnetic, one component using a styrene-acryl resin as a binder, manufactured by an emulsion polymerization method. The toner 121 has, e.g., a volume average particle size of 6.8 micron meters and a circularity of 0.97. A measurement device, Coulter Multisizer 2 (made by Beckman Coulter, Inc) is used for measurement of volume average particle size, and a flow type particle image analyzer FPIA-3000 (made by Sysmex Corporation) is used for measurement of circularity.

FIG. 7 is a schematic cross section showing a structure of the developing roller 145. The developing roller 145 is structured of an elastic layer 145c on a conducting core metal 145b as a shaft. As a material of the elastic layer 145c, a general rubber material such as, e.g., a silicone rubber, and a urethane rubber, can be used. More specifically, the elastic layer 145c is formed of a polyether based polyol and an aliphatic isocyanate as a base polymer. As a conducting agent, carbon blacks such as, e.g., acetylene black and Ketjen black are added.

An isocyanate processing is used for a surface of the elastic layer 145c of the developing roller 145 to render the toner 121 carried properly on the surface of the developing roller 145. A liquid for isocyanate processing is made by solving an isocyanate compound in an organic solvent such as, e. g, ethyl acetate and by adding black carbon such as, e.g., acetylene black and Ketjen black to the solvent. As the isocyanate compound, such as, e.g., diphenylmethane isocyanate, para-phenylene diisocyanate, and trilene diisocyanate are used. After the isocyanate processing liquid is dried, the charge property of the surface of the developing roller 145 is evenly improved by wiping the surface of the developing roller 145 with a cloth or the like dipped in an isopropyl alcohol as an organic solvent.

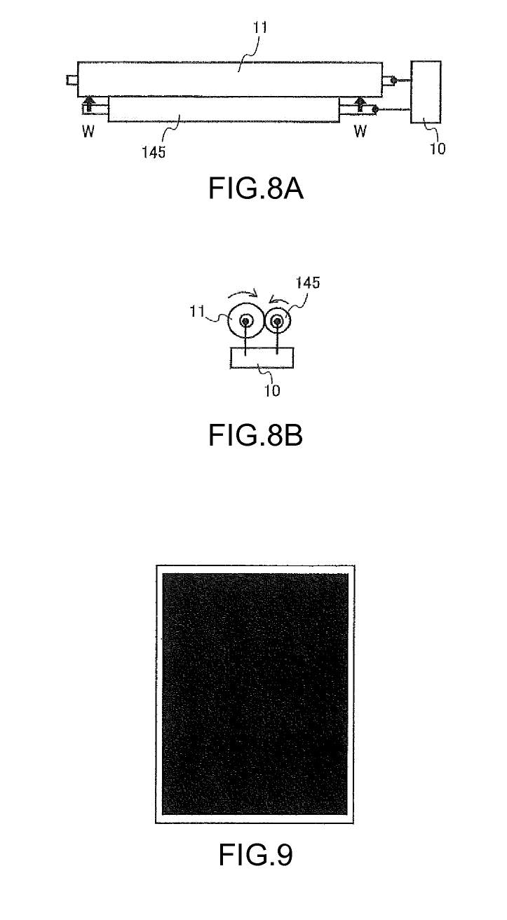

A measuring method of a resistance value of the developing roller 145 is described in referring to FIGS. 8A, 8B. High Resistance Meter 4339B (made by Agilent Technologies) indicated with reference number 10 was used for measuring the resistance value of the developing roller 145. The developing roller 145 was made to contact a metal roller 11 formed of a SUS (steel use stainless) material having a diameter of 30 mm in exerting a load W of 500 g to each end thereof. The metal roller 11 was rotated with a speed of 50 rpm; the core metal 145b of the developing roller 145 was applied at a voltage of −100 V; measurements of 100 points were executed per one rotation of the developing roller 145, and the mean value of the measurements was set as the resistance value of the roller. The resistance value of the developing roller 145 is preferably in a range between 1×10⁴ and 1×10⁸ Ohm. In this embodiment, the developing roller 145 having a resistance value of 1×10⁵ Ohm was used.

It is to be noted that in the first embodiment, the outer diameter of the developing roller 145 was set to 22.0 mm. The diameter of the core metal 145b and the thickness of the elastic layer 145c are described below. The developing blade 144 was made of the SUS material and had a plate thickness of 0.08 mm; a portion contacting the developing roller 145 was subject to a curving treatment; the radius of curvature of the curved portion was set to 0.35 mm. The line pressure of the developing blade 144 exerted to the developing roller 145 was set to 40 gf/cm.

In consideration of the setting condition of the developing blade 144 thus described, it is required to examine the surface roughness and resistance value of the developing roller 145 to make the toner layer thickness on the developing roller 145 and the toner charge amount to be desired amounts. As a ten point mean roughness Rz (JIS B0601-1994) of the surface of the developing roller 145, the roughness of 2 to 10 micron meters is appropriate. The developing roller 145 employed in the first embodiment had an Rz value of 5 micron meters. It is to be noted that the measurement of the surface roughness was done with a measurement device, Surf Corder SEF3500 (made by Kosaka Laboratory Ltd.); the probe radius of the measuring instrument was 2 micron meters; the probe pressure was 0.7 mN; the feeding speed of the probe was 0.1 mm/sec.

The photosensitive drum 131 was set to have a diameter of 40 mm. The spring 170 employed was of 700 gf to render the developing roller 145 encroach the photosensitive drum 131 by a thickness 0.06 mm. It is to be noted that, as shown in FIG. 4, the spring 170 is attached to one side of the developing device 110 and further to the other side, not shown.

The first supply roller 143A and the second supply roller 143B are formed with a silicone rubber sponge on the conducting core metal as a shaft. The silicone rubber sponge is produced by molding an unvulcanized silicone rubber compound with, e.g., an extruding method and by foaming the compound during vulcanizing process with heat application. The silicone rubber compound is formed by adding a reinforcing silica filler, a vulcanizer required for vulcanization curing, and a foaming agent to various raw rubbers such as, e.g., dimethyl silicone raw rubber, methyl phenyl silicone raw rubber. As a foaming agent, inorganic foaming agents such as sodium bicarbonate, and organic foaming agents such as ADCA (azodicarbonamide) are used. To provide a semiconductive feature, such as, e.g., acetylene black and carbon black may be added. The hardness of the first supply roller 143A and the second supply roller 143B is adjusted by the addition amount of the vulcanizer.

So-called porous eyes or holes, or namely fine holes produced by foaming, of the first supply roller 143A and the second supply roller 143B used in the first embodiment had a diameter of 200 to 500 micron meters. The Asker F hardness of supply rollers is 30 to 70 degrees as a proper hardness; the first supply roller 143A and the second supply roller 143B used in the first embodiment had the Asker F hardness of 63 degrees and the rubber thickness of 4 mm.

The resistance values of the first supply roller 143A and the second supply roller 143B are preferably in a range between 1×10⁴ and 1×10⁸ Ohm where the load W was 200 g and where the applied voltage was −300 V using the measuring method shown in FIGS. 8A, 8B. In the first embodiment, therefore, the resistance values of the first supply roller 143A and the second supply roller 143B were set to 1×10⁵ Ohm. The first supply roller 143A and the second supply roller 143B were disposed as to encroach the developing roller 145 by 0.7 mm, respectively, and were rotated in the reverse direction to the developing roller 145 at the facing area.

The following Table 1 shows a specification of gears employed in the first embodiment. With this structure, a circumferential speed ratio of the developing roller 145 to the photosensitive drum 131 becomes 1.34. A circumferential speed ratio of the first supply roller 143A and the second supply roller 143B to the developing roller 145 becomes 0.96.

TABLE 1
Gear Specification

| | | | | Tooth | Tip | | |
|---|---|---|---|---|---|---|---|
| | Tooth | Helix Angle | | Width | Diameter | | |
| | Number | (degree) | Module | (mm) | (mm) | SRR | GP |
| Driving motor gear 32 | 12 | 20 | 0.4 | — | 5.9 | 1.00 | 0.58 |
| Drum gear 33a | 215 | 20 | 0.4 | 9.5 | 91.5 | 17.92 | 0.58 |
| Developing unit gear 34a | 113 | 20 | 0.4 | 20.0 | 48.1 | 9.42 | 0.58 |
| Developing unit idle gear 27b | 69 | 20 | 0.3 | 14.0 | 22.4 | 9.42 | 0.96 |
| Developing roller gear 35 | 54 | 20 | 0.3 | 13.0 | 17.2 | 7.37 | 0.96 |
| 1^{st} toner supply roller gear 36 | 48 | 20 | 0.3 | 13.0 | 15.1 | 6.55 | 0.96 |
| Idle gear 37 | 26 | 20 | 0.3 | 14.5 | 8.3 | 3.55 | 0.96 |
| 2^{nd} toner supply roller gear 38 | 48 | 20 | 0.3 | 13.0 | 15.1 | 6.55 | 0.96 |

“SRR” stands for speed reduction ratio relative to driving motor gear 32
“GR” stands for gear pitch on printing image

In operation of the developing device 110 during image formation, the photosensitive drum 131, the developing roller 145, the first supply roller 143A, and the second supply roller 143B rotate in the arrow direction shown in FIG. 2 according to the rotation of the drive motor 166. The first supply roller 143A, and the second supply roller 143B, which are formed of a sponge type elastic body, rotate in carrying the toner 121 on the roller surface and the porous holes, and reach a contacting area for contacting the developing roller 145. The supply roller power source 157 applies a direct current voltage of −300 V to the first supply roller 143A and the second supply roller 143B. The developing roller power source 156 applies a direct current voltage of −200 V to the developing roller 145. The toner 121 negatively charged from the potential difference produced between the developing roller 145 and the first and second supply rollers 143A, 143B is supplied to the developing roller 145.

The toner 121 carried on the surface of the developing roller 145 is developed to electrostatic latent images formed on the photosensitive drum 131 after made to a thin layer with the developing blade 144 applied with the direct current voltage of −300 V from the developing blade power source 159. A weight per unit area of the toner layer made thinner by the developing blade 144 is set to 0.45 to 0.65 mg/cm².

Hereinafter, a confirmation method of effects brought by the image forming apparatus 100 according to the first embodiment is described.

### Printing Examination Conditions

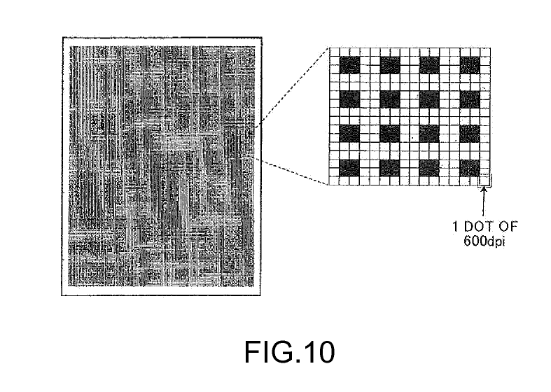

During this examination, the circumferential speed of the photosensitive drum 131 was set to 86 mm/s and 191 mm/s as two ways. The thickness of the elastic layer 145c of the developing roller 145 was set to 0.3 mm, 0.5 mm, 1.0 mm, 2.0 mm, 2.5 mm, 3.0 mm, and 5.0 mm. The outer diameter of the developing roller 145 was set uniformly to 22.0 mm, but the outer diameter of the core metal 145b was varied to adjust the thickness of the elastic layer 145c. The MD-1 hardness of the elastic layer 154c of the developing roller 145 was set to 35 degrees, 40 degrees, 50 degrees, 60 degrees, 70 degrees, and 75 degrees. The MD-1 hardness was defined from a value measured with Micro Rubber Hardness Tester MD-1 capa, made by Kobunshi Keiki Co., Ltd. The probe used at that time was a type A (cylinder shape, 0.16 mm diameter). It is to be noted that the MD-1 hardness measured herein was the measured value of the entire developing roller 145. More specifically, because the MD-1 hardness is measuring the hardness of a tiny region (in the thickness direction) of the topmost layer, the MD-1 hardness is not affected from the thickness of the elastic layer 145c. With the above combinations, the image forming apparatus 100 operated printing, and occurrences of jitter were checked with the operator's eyes. The jitter was pitch unevenness appearing in a case where, e.g., the developing roller is shaken or vibrated. The printing pattern to confirm the existence or non-existence of the jitter was a full solid image shown in FIG. 9 and a two by tow image shown in FIG. 10. The two by two image was formed with two dots by two dots patterns of 600 dpi, which were arranged with two dots intervals.

### Examination Results

Tables 2, 3 shows examination results on the printing examination conditions described above. Table 2 shows the results of printing the full solid image and Table 3 shows the results of printing the two by two image. In Tables 2, 3, the letter “G” stands for that any jitter has not occurred (Good) and the letter “P” stands for that jitter has occurred (Poor). The letter “F” stands for that any jitter has not occurred but other failure has occurred on a printed image (Fair).

TABLE 2
Result of Solid Image Printing

| Elastic Layer Thickness | | | | | | |
|---|---|---|---|---|---|---|
| 0.3 | 0.5 | 1.0 | 2.0 | 2.5 | 3.0 | 5.0 |
| mm | mm | mm | mm | mm | mm | mm |

Photosensitive Drum Circumferential Speed: 86 mm/s

| | | | | | | | | |
|---|---|---|---|---|---|---|---|---|
| MD-1 | 35 | P | P | P | P | P | P | P |
| Hardness | 40 | G | G | G | G | G | P | P |
| [degree] | 50 | G | G | G | G | G | P | P |
| | 60 | G | G | G | G | G | P | P |
| | 70 | G | G | G | G | G | P | P |
| | 75 | G | G | G | G | G | P | P |

Photosensitive Drum Circumferential Speed: 191 mm/s

| | | | | | | | | |
|---|---|---|---|---|---|---|---|---|
| MD-1 | 35 | G | G | G | G | P | P | P |
| Hardness | 40 | G | G | G | G | G | P | P |
| [degree] | 50 | G | G | G | G | G | G | P |
| | 60 | G | G | G | G | G | G | P |
| | 70 | G | G | G | G | G | G | G |
| | 75 | G | G | G | G | G | G | G |

TABLE 3
Result of Two by Two Image Printing

| Elastic Layer Thickness | | | | | | |
|---|---|---|---|---|---|---|
| 0.3 | 0.5 | 1.0 | 2.0 | 2.5 | 3.0 | 5.0 |
| mm | mm | mm | mm | mm | mm | mm |

Photosensitive Drum Circumferential Speed: 86 mm/s

| | | | | | | | | |
|---|---|---|---|---|---|---|---|---|
| MD-1 Hardness | 35 | F | G | G | G | G | G | G |
| [degree] | 40 | F | G | G | G | G | G | G |
| | 50 | F | G | G | G | G | G | G |
| | 60 | F | G | G | G | G | G | G |
| | 70 | F | G | G | G | G | G | G |
| | 75 | F | F | F | F | F | G | G |

Photosensitive Drum Circumferential Speed: 191 mm/s

| | | | | | | | | |
|---|---|---|---|---|---|---|---|---|
| MD-1 Hardness | 35 | F | G | G | G | G | G | G |
| [degree] | 40 | F | G | G | G | G | G | G |
| | 50 | F | G | G | G | G | G | G |
| | 60 | F | G | G | G | G | G | G |
| | 70 | F | G | G | G | G | G | G |
| | 75 | F | F | F | F | F | F | G |

According to the printing results of the full sold image in Table 2, no jitter occurred regardless the circumferential speed of the photosensitive drum where the thickness of the elastic layer 145c of the developing roller 145 was 2.5 mm or less and where the MD-1 hardness was 40 degrees or more. It is therefore assumed that no jitter would occur up to 100 degrees as the maximum value of the MD-1 hardness. It is also assumed that no jitter would occur even where the thickness of the elastic layer 145c of the developing roller 145 becomes further thinner. It is therefore assumed that the elastic layer 145c of the developing roller 145 is good if having the thickness more than 0 mm. This is because the elastic force from the spring 170 is considered to be exerted to an area between the developing roller 145 and the photosensitive drum 131, where the developing roller 145 is urged toward the photosensitive drum 131 by elastic force from the spring 170, even where the elastic layer 145c of the developing roller 145 has a hard hardness and a thinner thickness. To the contrary, where the elastic layer 145c of the developing roller 145 has a softer hardness and a thicker thickness, it is assumed that some jitter may occur because the where the elastic layer 145c of the developing roller 145 is easily shaken or vibrated from the elastic force of the spring 170 and the elastic force of the elastic layer 145c.

With the printing results in the two by two image in Table 3, no jitter occurred in any combination. It is therefore assumed that no jitter would occur up to 100 degrees as the maximum value original document the MD-1 hardness. It is also assumed that the elastic layer 145c of the developing roller 145 is good if having the thickness more than 0 mm. To the contrary, where the elastic layer 145c had either the MD-1 hardness of 75 degrees or the thickness of 3.0 mm, the two by two image showed an occurrence of flaw of low dot reproducibility. The low dot reproducibility herein means phenomena such that dots are blurred as to enlarge the dot diameter of the two by two image, that a part of a dot or dots is lacked, and that toner is scattered to non-dot regions of the two by two image. This is caused by a higher contact pressure between the developing roller 145 and the photosensitive drum 131 where the developing roller 145 has a harder hardness or a thinner thickness. Even in such a situation, no jitter was confirmed.

With the full solid image, if the elastic layer 145c is thick, the elastic layer 145c tends to be readily shaken or vibrated when the developing roller 145 and the photosensitive drum 131 contact in a sliding manner. If the sold printing is performed, the surface of the developing roller 145 is in an exposed state, because most of the toner 121 on the developing roller 145 is developed at the photosensitive drum 131. Because the exposed surface has a higher friction coefficient in comparison with a situation that the toner layer is formed on the surface of the developing roller 145, the developing roller 145 is more affected from frictions to the photosensitive drum 131, thereby further making the elastic layer 145c subject to shaken or vibrated states. On the other hand, the reason why no jitter occurred with the two by two image is based on that the developing roller 145 is less affected from frictions to the photosensitive drum 131 where the undeveloped toner 121 remains on the developing roller 145. A cycle of jitter occurring on the solid image resulted in approximately 1.1 mm to 1.5 mm depending on the hardness and thickness of the elastic layer 145c, as different from any of the gear pitch shown in Table 1.

According to the examination results described above, the image forming apparatus 100 of the first embodiment can suppress jitter from occurring where the elastic layer 145c of the developing roller 145 is set to have a thickness of 2.5 mm or less and the MD-1 hardness of 40 degrees or more. It is to be noted that the elastic layer 145c of the developing roller 145 is good if having the thickness more than 0 mm, and is also good if having the MD-1 hardness of 100 degrees or less. Particularly, where the elastic layer 145c of the developing roller 145 is set to have a thickness of 0.5 mm or more and 2.5 mm or less and the MD-1 hardness of 40 degrees or more and 70 degrees or less, the image forming apparatus can suppress jitter from occurring and can obtain excellent printing results.

Various causes of jitter are conceivable. For example, as described above, jitter may occur from unevenness of rotation due to vibrations or shaken behaviors in meshing gears. The image forming apparatus 100 according to this embodiment can suppress such jitter from occurring from the structure that the gear 181a rotating the photosensitive drum 131 and the gears 145a, 190a, 191a rotating the developing roller 145 are made not meshing each other. It is also considered that such jitter may occur from vibration of the elastic layer 154c of the developing roller 145. Such jitter may be suppressed by urging the developing roller 145 in a direction toward the photosensitive drum 131 with the elastic force and by setting the thickness and the MD-1 hardness of the elastic layer 145c of the developing roller 145 to be a prescribed range.

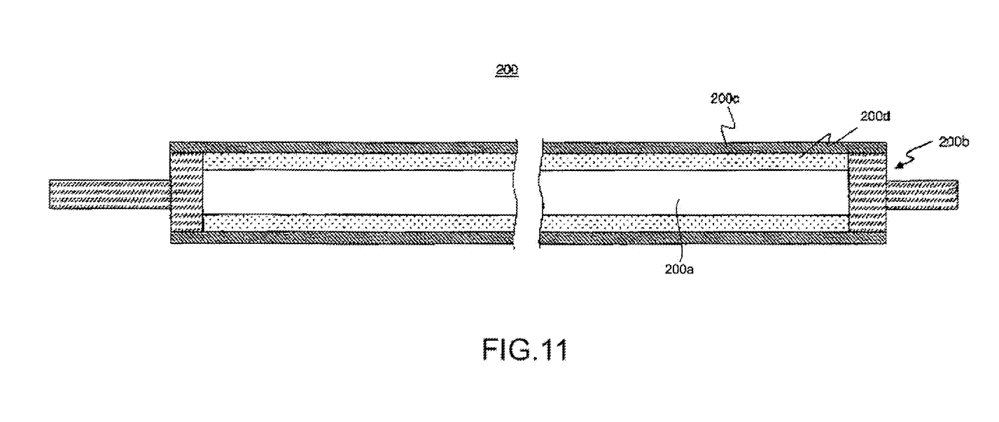

FIG. 11 shows a developing roller 200 having a hollow core metal 200b. Where the core metal 200b of the developing roller 200 has a hollow, or namely where the core metal 200b includes a hollow region 200a, no jitter occurs where an elastic layer 200c of the developing roller 200 has a thickness of 0.5 mm to 2.5 mm, where the MD-1 hardness of the elastic layer 200c is 40 to 70 degrees, and where the developing roller has a weight per unit length of 1.16 g/mm or more. Jitter may occur where a body portion 200d of the core metal 200b of the developing roller 200 has a thin thickness or in other words where the developing roller 200 has a light weight.

### Second Embodiment

### Printing Examination Conditions

As another examination, the circumferential speed of the photosensitive drum 131 was set to 86 mm/s and 191 mm/s as two ways. The thickness of the elastic layer 145c of the developing roller 145 was set to 0.3 mm, 0.5 mm, 1.0 mm, 2.0 mm, 2.5 mm, 3.0 mm, and 5.0 mm. The outer diameter of the developing roller 145 was set uniformly to 22.0 mm, but the outer diameter of the core metal 145b was varied to adjust the thickness of the elastic layer 145c. The repulsion elasticity (%) of the elastic layer 154c of the developing roller 145 was set to 60, 65, 75, 85, and 90. The repulsion elasticity was defined from a value measured according to JIS (Japanese Industrial Standard) K6255. With the above combinations, the image forming apparatus 100 operated printing, and occurrences of jitter were checked with the operator's eyes. The jitter was pitch unevenness appearing in a case where, e.g., the developing roller is shaken. The printing pattern to confirm the existence or non-existence of the jitter was a full solid image shown in FIG. 9 and a two by tow image shown in FIG. 10. The two by two image was formed with two dots×two dots patterns of 600 dpi, which were arranged with two dots intervals.

### Examination Results

Tables 4, 5 shows examination results on the printing examination conditions described above. Table 4 shows the results of printing the full solid image and Table 5 shows the results of printing the two by two image. In Tables 4, 5, the letter “G” stands for that any jitter has not occurred (Good) and the letter “P” stands for that jitter has occurred (Poor). The letter “F” stands for that jitter has occurred slightly but caused no problem level in use (Fair). In Table 5, the letter “N” stands for that any jitter has not occurred but other failure has occurred on a printed image (No Good).

TABLE 4
Result of Solid Image Printing

| Elastic Layer Thickness | | | | | | |
|---|---|---|---|---|---|---|
| 0.3 | 0.5 | 1.0 | 2.0 | 2.5 | 3.0 | 5.0 |
| mm | mm | mm | mm | mm | mm | mm |

Photosensitive Drum Circumferential Speed: 86 mm/s

| | | | | | | | | |
|---|---|---|---|---|---|---|---|---|
| Modulus of | 60 | P | P | P | P | P | P | P |
| Repulsion | 65 | G | G | G | G | G | P | P |
| Elasticity (%) | 75 | G | G | G | G | G | P | P |
| | 85 | G | G | G | G | G | P | P |
| | 90 | G | G | G | G | G | G | G |

Photosensitive Drum Circumferential Speed: 191 mm/s

| | | | | | | | | |
|---|---|---|---|---|---|---|---|---|
| Modulus of | 60 | G | G | G | G | P | P | P |
| Repulsion | 65 | G | G | G | G | G | P | P |
| Elasticity (%) | 75 | G | G | G | G | G | G | F |
| | 85 | G | G | G | G | G | G | G |
| | 90 | G | G | G | G | G | G | G |

TABLE 5
Result of Two by Two Image Printing

| Elastic Layer Thickness | | | | | | |
|---|---|---|---|---|---|---|
| 0.3 | 0.5 | 1.0 | 2.0 | 2.5 | 3.0 | 5.0 |
| mm | mm | mm | mm | mm | mm | mm |

Photosensitive Drum Circumferential Speed: 86 mm/s

| | | | | | | | | |
|---|---|---|---|---|---|---|---|---|
| Modulus of | 60 | N | G | G | G | G | G | G |
| Repulsion | 65 | N | G | G | G | G | G | G |
| Elasticity (%) | 75 | N | G | G | G | G | G | G |
| | 85 | N | G | G | G | G | G | G |
| | 90 | N | N | N | G | G | G | G |

Photosensitive Drum Circumferential Speed: 191 mm/s

| | | | | | | | | |
|---|---|---|---|---|---|---|---|---|
| Modulus of | 60 | N | G | G | G | G | G | G |
| Repulsion | 65 | N | G | G | G | G | G | G |
| Elasticity (%) | 75 | N | G | G | G | G | G | G |
| | 85 | N | G | G | G | G | G | G |
| | 90 | N | N | N | G | G | G | G |

According to the printing results of the full sold image in Table 4, no jitter occurred regardless the circumferential speed of the photosensitive drum where the thickness of the elastic layer 145c of the developing roller 145 was 2.5 mm or less and where the repulsion elasticity was 65% or more. It is therefore assumed that no jitter would occur up to 100% as the maximum value of the repulsion elasticity. It is also assumed that no jitter would occur even where the thickness of the elastic layer 145c of the developing roller 145 becomes further thinner. It is therefore assumed that the elastic layer 145c of the developing roller 145 is good if having the thickness more than 0 mm. This is because the elastic force from the spring 170 is considered to be exerted to an area between the developing roller 145 and the photosensitive drum 131, where the developing roller 145 is urged toward the photosensitive drum 131 by elastic force from the spring 170, even where the elastic layer 145c of the developing roller 145 has a high repulsion elasticity and a thinner thickness. To the contrary, where the elastic layer 145c of the developing roller 145 has a lower repulsion elasticity and a thicker thickness, it is assumed that some jitter may occur because the where the elastic layer 145c of the developing roller 145 is easily shaken or vibrated from the elastic force of the spring 170 and the elastic force of the elastic layer 145c.

Where the repulsion elasticity was 90% or more, no jitter occurred even where the elastic layer 145c has a thickness of 2.5 mm or more. Accordingly, where the repulsion elasticity of the elastic layer 145c is 90% or more but 100% or less, it is assumed that no jitter would occur regardless the thickness of the elastic layer 145c. This is assumed because vibrations or shaken states of the elastic layer 145c are suppressed by a higher repulsion elasticity of the elastic layer 145c.

With the printing results in the two by two image in Table 5, no jitter occurred in any combination. To the contrary, where the elastic layer 145c had the thickness of 0.3 mm or where the elastic layer 145c had the repulsion elasticity of 90% or more and the thickness of 1.0 mm or less, the two by two image showed an occurrence of flaw of low dot reproducibility. The low dot reproducibility herein means phenomena such that dots are blurred as to enlarge the dot diameter of the two by two image, that a part of dots is lacked, and that toner is scattered to non-dot regions of the two by two image. This is caused by a higher contact pressure between the developing roller 145 and the photosensitive drum 131 where the developing roller 145 has a higher repulsion elasticity or a thinner thickness.

According to the examination results described above, the image forming apparatus 100 of the second embodiment can suppress jitter from occurring where the elastic layer 145c of the developing roller 145 is set to have a thickness of 2.5 mm or less and the repulsion elasticity of 65% or more. It is to be noted that the elastic layer 145c of the developing roller 145 is good if having the thickness more than 0 mm, and is also good if having the repulsion elasticity of 100% or less. Particularly, where the elastic layer 145c of the developing roller 145 is set to have a thickness of 0.5 mm or more and 2.5 mm or less and the repulsion elasticity of 65% or more and 85% or less, the image forming apparatus can suppress jitter from occurring and can obtain excellent printing results.

The image forming apparatus can suppress jitter from occurring where the elastic layer 145c of the developing roller 145 has a repulsion elasticity of 90% or more and 100% or less. Particularly, where the elastic layer 145c of the developing roller 145 is set to have a thickness of 2.0 mm or more and 5.0 mm or less and the repulsion elasticity of 90%, the image forming apparatus can suppress jitter from occurring and can obtain excellent printing results.

Various causes of jitter are conceivable. For example, as described above, jitter may occur from unevenness of rotation due to vibrations or shaken behaviors in meshing gears. The image forming apparatus 100 according to this embodiment can suppress such jitter from occurring from the structure that the gear 181a rotating the photosensitive drum 131 and the gears 145a, 190a, 191a rotating the developing roller 145 are made not meshing each other. It is also considered that such jitter may occur from vibration of the elastic layer 154c of the developing roller 145. Such jitter may be suppressed by urging the developing roller 145 in a direction toward the photosensitive drum 131 with the elastic force and by setting the thickness and the repulsion elasticity of the elastic layer 145c of the developing roller 145 to be a prescribed range.

It was also confirmed that the image forming apparatus showed satisfactory results to suppress jitter with any combination of the range that the elastic layer 145c has a thickness of 2.5 mm or less and an MD-1 hardness of 40 degrees or more and the range that the elastic layer 145c has a thickness of 2.5 mm or less and a repulsion elasticity of 64% or more.

In the first and second embodiments described above, it is described that the developing device 110 includes the two supply rollers, 143A, 143 B, but the developing device 110 may include a single supply roller. In the first and second embodiments described above, the image forming apparatus 100 is described by the example of the monochrome printer of a direct transfer method, but it is not limited to this structure. For example, this invention is applicable to multicolor image forming apparatuses including plural developing devices 110, or image forming apparatuses of an intermediate transfer method. The image forming apparatus is applicable to MFPs (Multi-Function Printers/Peripherals), facsimile machines, and photocopiers.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An image forming apparatus comprising:
an image carrier; and
a developer carrier supplying a developer to the image carrier,
wherein the developer carrier includes an elastic layer having a thickness of 2.5 mm or less and having an MD-1 hardness of 40 degrees or more.

2. The image forming apparatus according to claim 1, wherein the thickness of the elastic layer is 0.5 mm or more and 2.5 mm or less.

3. The image forming apparatus according to claim 1, wherein the MD-1 hardness of the elastic layer is 40 degrees or more and 70 degrees or less.

4. The image forming apparatus according to claim 1, further comprising:
a first unit containing the image carrier;
a second unit containing the developer carrier; and
an urging member having an elasticity for urging at least either one of the first unit and the second unit to contact the image carrier with the developer carrier,
wherein the first unit and the second unit, respectively, are detachably attached to the image forming apparatus.

5. The image forming apparatus according to claim 1, wherein the urging member is a spring whose one end is attached to the first unit and whose the other end is attached to the second unit.

6. The image forming apparatus according to claim 1, wherein drive force for rotating the image carrier and drive force for rotating the developer carrier are separately inputted.

7. The image forming apparatus according to claim 1, further comprising:
a first gear;
a drive source rotating the first gear;
at least one image carrier gear for rotating the image carrier; and
at least one developer carrier gear for rotating the developer carrier;
wherein the image carrier gear and the developer carrier gear mesh the first gear whereas the image carrier gear and the developer carrier gear do not mesh each other.

8. The image forming apparatus according to claim 1, further comprising:
a first drive source for rotating the image carrier; and
a second drive source for rotating the developer carrier.

9. The image forming apparatus according to claim 1, further comprising:
a first gear;
a drive source rotating the first gear;
a first coupling member having a second gear at one end thereof and a first fitting hole at the other end thereof;
a second coupling member having a third gear at one end thereof and a second fitting hole at the other end thereof;
a connection member having a second coupling reception member to be inserted into the second fitting hole at one end thereof and a fourth gear at the other end thereof,
wherein the image carrier has a first coupling reception member to be inserted into the first fitting hole at one end thereof and rotates according to the rotation of the first gear by inserting the first coupling reception member into the first fitting hole, and
wherein the developer carrier has a fifth gear at one end thereof and rotates according to the rotation of the first gear by inserting the second coupling reception member into the second fitting hole and by meshing the fourth gear with the fifth gear.

10. The image forming apparatus according to claim 1, wherein the developer carrier has a solid core metal.

11. The image forming apparatus according to claim 1, wherein the developer carrier has a hollow core metal.

12. The image forming apparatus according to claim 1, wherein the elastic layer has a modulus of repulsion elasticity of 65% or more.

13. The image forming apparatus according to claim 12, wherein the thickness of the elastic layer is 0.5 mm or more and 2.5 mm or less.

14. The image forming apparatus according to claim 12, wherein the modulus of repulsion elasticity of the elastic layer is 65% or more and 85% or less.

15. The image forming apparatus according to claim 1, further comprising an urging member having an elasticity for urging at least either one of the first unit and the second unit to contact the image carrier with the developer carrier,
wherein the elastic layer has a modulus of repulsion elasticity of 90% or more.

16. An image forming apparatus comprising:
an image carrier; and
a developer carrier supplying a developer to the image carrier,
wherein the developer carrier includes an elastic layer having a thickness of 2.5 mm or less and having a modulus of repulsion elasticity of 65% or more.

17. The image forming apparatus according to claim 16, wherein the thickness of the elastic layer is 0.5 mm or more and 2.5 mm or less.

18. The image forming apparatus according to claim 16, wherein the modulus of repulsion elasticity of the elastic layer is 65% or more and 85% or less.

19. An image forming apparatus comprising:
an image carrier;
a developer carrier supplying a developer to the image carrier, and
an urging member having an elasticity for urging at least either one of the first unit and the second unit to contact the image carrier with the developer carrier,
wherein the developer carrier includes an elastic layer having a modulus of repulsion elasticity of 90% or more.

20. The image forming apparatus according to claim 19, wherein the thickness of the elastic layer is 0.5 mm or more and 2.5 mm or less.
